(19) United States
(12) Patent Application Publication
(10) Pub. No.: US 2008/0189265 A1
(43) Pub. Date: Aug. 7, 2008

(54) Techniques to manage vocabulary terms for a taxonomy system

(75) Inventors: Viktoriya Taranov, Bellevue, WA (US); Daniel E. Kogan, Issaquah, WA (US); Patrick C. Miller, Sammamish, WA (US); Michal K. Piaseczny, Waterloo (CA); Lauren N. Antonoff, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/703,002

(22) Filed: Feb. 6, 2007

(51) Int. Cl. G06F 17/30

(52) U.S. Cl. 707/5

(57) ABSTRACT

Techniques to manage vocabulary terms for a taxonomy system are described. An apparatus may comprise a managed taxonomy system having a vocabulary management module to manage a taxonomy of formal vocabulary terms organized in a hierarchical structure. The taxonomy may include a category for informal vocabulary terms stored as a list of keywords. Other embodiments are described and claimed.

### BACKGROUND

A managed taxonomy system attempts to manage a taxonomy for an application, device or network. A taxonomy attempts to define a common or standard vocabulary for interacting with an application or system. The standard vocabulary may then be used for different applications, such as classification applications, search applications, tagging applications, and so forth. To create a standard vocabulary, managed taxonomy systems attempt to build and manage a highly structured and formalized hierarchy of standard vocabulary terms. Managed taxonomy systems, however, are typically difficult to maintain and manage, particularly across heterogeneous systems. Introduction of a new vocabulary term often includes a formal review and acceptance by a taxonomy manager. When a system has a large number of users, however, the number of new vocabulary terms may quickly overwhelm such formal procedures. Further, a highly structured taxonomy system is often very rigid and therefore cannot adapt quickly to new use scenarios or changes in vocabulary, which is prevalent for online applications such as the Internet. Consequently, there may be a need for improved techniques for managing vocabulary terms for a managed taxonomy system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments may be generally directed to techniques to manage vocabulary terms for a managed taxonomy system. In particular, some embodiments may be directed to techniques for managing informal vocabulary terms for a managed taxonomy system. In one embodiment, for example, an apparatus such as a managed taxonomy system may include a vocabulary management module to manage a taxonomy of formal vocabulary terms organized in a hierarchical structure. The taxonomy may include a defined category for informal vocabulary terms stored as a list of keywords. In this manner, the managed taxonomy system may give informal vocabulary terms a basic structure that allows the informal vocabulary terms to be managed by the managed taxonomy system, thereby allowing the informal vocabulary terms an opportunity to evolve into formal vocabulary terms over time based on various decision criteria. Other embodiments are described and claimed.

### BRIEF DESCRIPTION OF THE DRAWINGS

FIG. 1 illustrates one embodiment of managed taxonomy system.

FIG. 2 illustrates one embodiment of managed taxonomy.

FIG. 3 illustrates one embodiment of a logic flow.

FIG. 4 illustrates one embodiment of a computing system architecture.

### DETAILED DESCRIPTION

Various embodiments may comprise one or more elements. An element may comprise any feature, characteristic, structure or operation described in connection with an embodiment. Examples of elements may include hardware elements, software elements, physical elements, or any combination thereof. Although an embodiment may be described with a limited number of elements in a certain arrangement by way of example, the embodiment may include more or less elements in alternate arrangements as desired for a given implementation. It is worthy to note that any references to “one embodiment” or “an embodiment” are not necessarily referring to the same embodiment.

Various embodiments may be generally directed to techniques to manage vocabulary terms for a managed taxonomy system. A taxonomy may generally refer to a structure, method or technique for classifying information or data. A taxonomy is typically composed of taxonomic units singularly known as taxon and collectively known as taxa. In various embodiments, the taxon may comprise one or more vocabulary terms, while the taxa may include the entire set of vocabulary terms defined for a given system. The vocabulary terms may include various types, including formal vocabulary terms and informal vocabulary terms. A managed taxonomy may refer to a taxonomy that is managed in accordance with a formal set of rules, procedures or guidelines for a given system. A managed taxonomy system may be any system arranged to store, process, communicate, and otherwise manage a defined taxonomy for an electronic system or collection of electronic systems.

More particularly, various embodiments may be directed to techniques for managing informal vocabulary terms for a managed taxonomy system. An informal vocabulary term may generally refer to a new vocabulary term introduced into a managed taxonomy system without formal acceptance in the taxonomy hierarchy. The managed taxonomy system may provide the informal vocabulary term some basic structure. The basic structure is typically less than the formal structure given to formal vocabulary terms. For example, the basic structure may be a specifically defined category for informal vocabulary terms. In some embodiments, the specifically defined category may be referred to as a “hybrid” category. The managed taxonomy system may use the hybrid category to perform basic taxonomy management operations for the informal vocabulary terms, while reducing or avoiding the need to process the informal vocabulary terms in accordance with the formal review procedures implemented for the managed taxonomy system.

By way of contrast, formal vocabulary terms may generally refer to vocabulary terms that have been through a formal review process for full acceptance into the taxonomy hierarchy. The managed taxonomy system may review a candidate vocabulary term for acceptance into the managed taxonomy. Part of the formal review process may include identifying whether the candidate vocabulary term has a logical position in the hierarchical organization of the taxonomy. For example, if the taxonomy is organized as a tree hierarchy, the managed taxonomy system may arrange the formal vocabulary terms as nodes with links to parent and/or child nodes. The managed taxonomy system may employ certain semantic and syntax rules to determine the appropriate position for the candidate vocabulary term in this rigid hierarchical structure. The managed taxonomy system may also define certain characteristics or features for formal vocabulary terms, such as a syntax rules, associations with certain resources or data objects, equality relationships or synonyms with other formal vocabulary terms, ontological relationships with other formal vocabulary terms, context, and so forth. The number and type of formal review and acceptance procedures for a managed taxonomy system are virtually limitless and may vary by implementation.

In some cases, the formal review and acceptance procedures typically implemented for a managed taxonomy system may create various problems in a dynamic system environment. Often such formal procedures are performed by a human manager, sometimes referred to as a taxonomist. In some cases, the formal procedures may be automated by an application program with certain rule sets, heuristics, fuzzy logic, parameters, and so forth. In both cases, the formal procedures may operate as a potential bottleneck in introducing new vocabulary terms into the managed taxonomy. For systems with a large user population, particularly across heterogeneous systems or platforms, the volume and rate of change in vocabulary terms may be exponential. Consequently, the need to implement formal review procedures for every vocabulary term may significantly impact the ability of the managed taxonomy system to process and manage the influx of new vocabulary terms or changes in existing vocabulary terms.

Various embodiments may attempt to solve these and other potential problems. In one embodiment, for example, a managed taxonomy system may include a vocabulary management module to manage multiple vocabulary terms for a managed taxonomy. The vocabulary management module may include a hybrid category for storing informal vocabulary terms. One example of a hybrid category may include a hierarchical category that includes the informal vocabulary terms as a flat list of keywords. The informal vocabulary terms may include any new vocabulary term associated with a given resource. The informal vocabulary terms typically do not have any previously defined relationships with the formal vocabulary terms in the managed taxonomy. The managed taxonomy system, however, may allow informal vocabulary terms to evolve into formal vocabulary terms over time based on usage and other decision criteria. For example, increased use of informal vocabulary terms with certain data sets may reveal relationships with formal vocabulary terms within the managed taxonomy system. In this manner, new vocabulary terms may be given some basic structure for use with a managed taxonomy system, and the use and definition for informal vocabulary terms may become more formalized over time based on usage of the informal vocabulary terms. As a result, the managed taxonomy system may be robust enough to respond to changes in vocabulary usage over time.

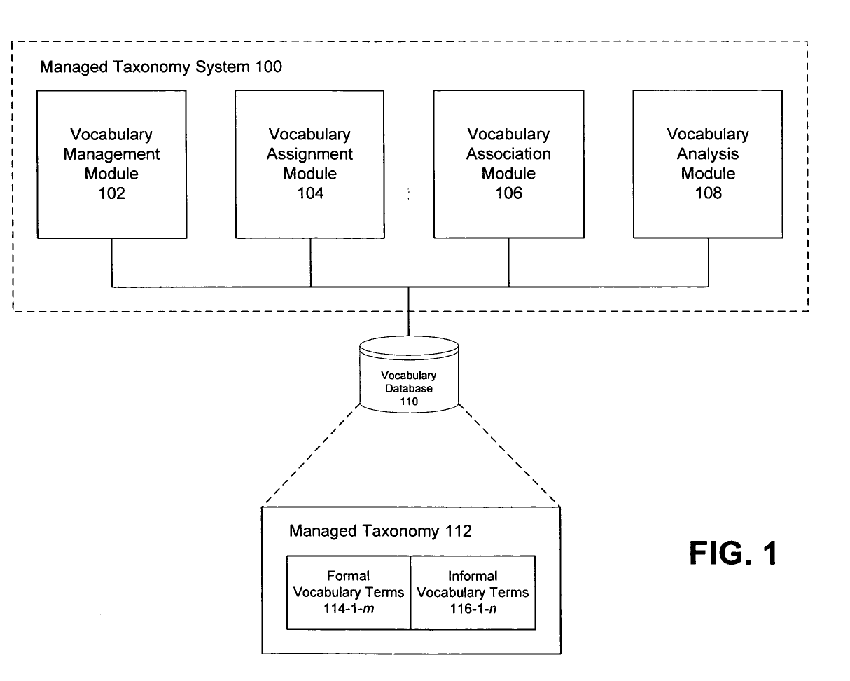

FIG. 1 illustrates a block diagram of a managed taxonomy system 100. The managed taxonomy system 100 may represent any system arranged to store, process, communicate, and otherwise manage a defined or managed taxonomy for an electronic system or collection of electronic systems. As shown in FIG. 1, one embodiment of the managed taxonomy system 100 may include a vocabulary management module 102, a vocabulary assignment module 104, a vocabulary association module 106, a vocabulary analysis module 108, and a vocabulary database 110.

As used herein the term “module” may include any structure implemented using hardware elements, software elements, or a combination of hardware and software elements. In one embodiment, for example, the modules described herein are typically implemented as software elements stored in memory and executed by a processor to perform certain defined operations. It may be appreciated that the defined operations, however, may be implemented using more or less modules as desired for a given implementation. It may be further appreciated that the defined operations may be implemented using hardware elements based on various design and performance constraints. The embodiments are not limited in this context.

In various embodiments, the managed taxonomy system 100 may be used to manage any defined taxonomy. An entity such as a company, business or enterprise may use different application programs to manage information across the entity. Often the vocabulary and taxonomy for an entity varies with the type of entity and a given set of products and/or services. In one embodiment, for example, the managed taxonomy system 100 may be used to manage specific vocabulary terms for entities operating within a computing and/or communications environment, sometimes referred to as an online environment. In this context such vocabulary terms are sometimes referred to as “metadata.” Metadata may refer to structured, encoded data that describe characteristics of information-bearing entities to aid in the identification, discovery, assessment, and management of the described entities. Generally, a set of metadata describes a single object or set of data, called a resource. Metadata may be of particular use for such applications as information retrieval, information cataloging, and the semantic web. For example, the vocabulary terms may be metadata used as tags for tagging operations. A tag is a relevant keyword or term associated with or assigned to a piece of information or resource. The tag may thus describe the resource and enable keyword-based classification of the resource.

One problem with conventional managed taxonomy systems is integrating the vocabulary informality typically associated with tagging operations and other “Web 2.0” applications with the vocabulary formality typically used for business and enterprise systems. Tags are usually chosen informally and personally by the author/creator of the item, and are not typically part of some formally defined classification scheme. Rather, tags are typically used in dynamic, flexible, automatically generated internet taxonomies for online resources, such as computer files, web pages, digital images, and intenet bookmarks. A business or enterprise, however, typically defines its vocabulary using a domain specific ontology. A managed taxonomy system for a business or enterprise may therefore face considerable challenges in balancing the creativity of growth with the certainty needed in a business environment.

Vocabulary structure for a system may be viewed as more of a continuum rather than a discrete series of binary choices. At one end of the continuum there is no managed vocabulary. People may associate keywords with a document, but there is no system in place to use them. Search consists solely of full text crawling. At the next level, the vocabulary is a flat list of keywords, which is a common well from which users can select a term. Depending on the infrastructure surrounding this vocabulary, you can still get some useful features out of the system. Different applications within the company can be speaking the same semantic language, allowing these different systems to communicate with each other. Another level is to track some sort of relationship between the various terms in the vocabulary. These associations are most likely derived from some sort of algorithmic processing by a computer, rather than by an actual human. Yet another level is defining previous associations, such as equality relationships. The equality relationships may comprise business specific synonyms in the vocabulary pushed into a custom thesaurus or dictionary. This may be useful when a product moves through various incarnations with different names, or when two different development teams within an enterprise try and consolidate their individual vocabularies into a single shared vocabulary. Still another level may include a taxonomy as previously described. Finally, the other end of the continuum may be an ontological vocabulary that adds named relationships to the vocabulary. Relationships like “competes with” or “makes” give an even greater amount of information to the rest of the system. It is at this point that you no longer need to know what you are searching for to find it. For example, a search may be performed for “back pain medication” without previous knowledge of particular back pain medications.

In various embodiments, the managed taxonomy system 100 attempts to operate within this vocabulary structure continuum. More particularly, the managed taxonomy system 100 attempts to provide a higher level of integration between the informal vocabulary terms generated by authors and creators of a resource (e.g., as used for tagging operations), with the formal vocabulary terms comprising part of a domain specific ontology used to typically define a vocabulary for business or enterprise operations. The managed taxonomy system 100 may be designed with a hybrid approach to vocabulary management, with certain areas of the vocabulary that are highly structured, and other areas of the vocabulary that are managed as a flat list of keywords. For example, the vocabulary terms dealing with specific product groups and their associated products for a business may be relatively straightforward to place in hierarchies with defined relationships. Vocabulary terms dealing with specific general technologies, however, may be not be used enough inside a given business to warrant the additional overhead of managing them in anything other than a keyword list. This hybrid approach allows a business to start from a very loose freeform based system and grow towards a more structured and possibly process driven vocabulary as their needs and sophistication warrant. Most companies will be in this hybrid state, with sections of their vocabulary being very polished where the data either tends to be more easily structured, or where certain business segments demand it (e.g., company organizational charts, legal terms, marketing terms, and so forth), while other areas may be less structured with more keyword buckets and where relationships are derived through algorithmic analysis or end user suggestions.

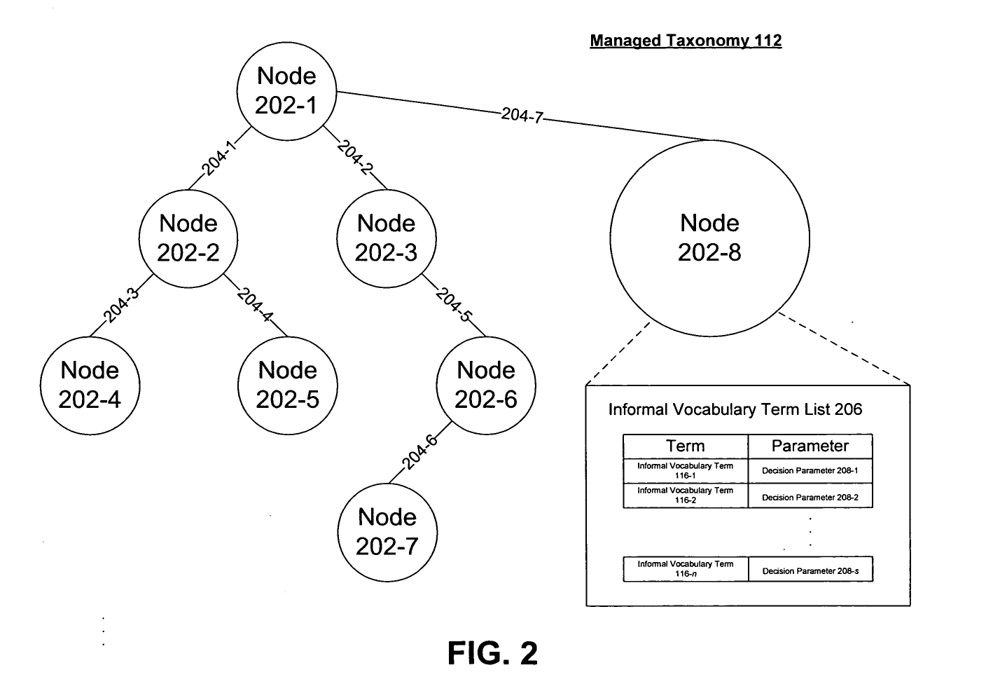

Referring again to FIG. 1, the managed taxonomy system 100 may include the vocabulary management module 102. The vocabulary management module 102 may be arranged to manage vocabulary terms for a managed taxonomy 112 stored by vocabulary database 110. The managed taxonomy 112 may comprise various types, such as formal vocabulary terms 114-1-m and informal vocabulary terms 116-1-n, where m and n represent positive integers. In one embodiment, for example, the vocabulary management module 102 may organize the managed taxonomy 112 with the formal vocabulary terms 114-1-m in a hierarchical structure. The vocabulary management module 102 may also create and maintain a hybrid category for informal vocabulary terms 116-1-n stored as a list of keywords. An exemplary managed taxonomy 112 may be described in more detail with reference to FIG. 2.

In one embodiment, for example, the managed taxonomy system 100 may include the vocabulary assignment module 104. Whenever an informal vocabulary term 116-1-n is introduced to the managed taxonomy system 100, the vocabulary management module 102 may store the informal vocabulary term 116-1-n with a hybrid category for the managed taxonomy 112 in the vocabulary database 110. The vocabulary management module 102 may send a request to the vocabulary assignment module 104. The vocabulary assignment module 104 may be arranged to assign a decision parameter to an informal vocabulary term 116-1-n. Once the vocabulary assignment module 104 assigns a decision parameter to the information vocabulary term 116-1-n, the vocabulary assignment module 104 may send the assigned decision parameter to the vocabulary analysis module 108 for monitoring and analysis operations.

In one embodiment, for example, the managed taxonomy system 100 may include the vocabulary association module 106. The vocabulary association module 106 may be arranged to associate an informal vocabulary term with a resource. The association operations are representative of tagging operations where a tag is associated with a given resource. For example, a data object such as a picture may be tagged with metadata such as a date, a time, a place, a photographer, an event, and so forth. Once an informal vocabulary term 116-1-n has been stored in the vocabulary database 110, the vocabulary management module 102 may send a message to the vocabulary association module 106 notifying the vocabulary association module 106 of the informal vocabulary term 116-1-n. A user interface or graphic user interface may be used to present a list of informal vocabulary terms 116-1-n to a user. A user may select one or more of the informal vocabulary terms 116-1-n, tag or associate the selected informal vocabulary term 116-1-n with a resource, and return a user tag/data selection to the vocabulary association module 106. The vocabulary association module 106 may store the association between the selected informal vocabulary term 116-1-n and the resource in the vocabulary database 110.

In one embodiment, for example, the managed taxonomy system 100 may include the vocabulary analysis module 108. The vocabulary analysis module 108 may be arranged to analyze a decision parameter for an informal vocabulary term 116-1-n. The vocabulary analysis module 108 may convert the informal vocabulary term 116-1-n to a formal vocabulary term 114-1-m based on the decision parameter. For example, the vocabulary analysis module 108 may convert an informal vocabulary term 116-1-n to a formal vocabulary term 114-1-m based on usage of the informal vocabulary term 116-1-n. Alternatively, a human being such as a taxonomy manager may convert the informal vocabulary term 116-1-n to a formal vocabulary term 114-1-m based on the decision parameter or other factors as desired for a given implementation.

In one embodiment, for example, the managed taxonomy system 100 may include the vocabulary database 110. Vocabulary database 110 may be used to store the managed taxonomy 112 for the managed taxonomy system 100. In one embodiment, for example, the managed taxonomy 112 may be implemented as a hierarchical structure of various types, commonly displaying parent-child relationships. Although one embodiment may describe a managed taxonomy 112 in terms of a hierarchical structure or organization, the managed taxonomy 112 may also be implemented as other non-hierarchical structures having various topologies, such as network structures, organization of objects into groups or classes, alphabetical lists, keyword lists, and so forth. The embodiments are not limited in this context.

FIG. 2 illustrates a managed taxonomy 112. In one embodiment, for example, the managed taxonomy 112 may represent a hierarchical taxonomy displaying various parent-child relationships. A hierarchical taxonomy is a tree structure of classifications for a given set of objects. It is also sometimes referred to as a containment hierarchy. At the top of this structure is a single classification referred to as the root node that applies to all objects. Nodes below the root node are more specific classifications that apply to subsets of the total set of classified objects.

As show in FIG. 2, the managed taxonomy 112 may comprise various classification nodes 202-1-p, with p representing any positive integer. The various classification nodes 202-1-p may be connected together via links 204-1-q, with q representing any positive integer, where q typically represents p−1. The classification node 202-1 may represent the root node, and nodes 202-2 through 202-6 representing more specific classifications that apply to subsets of the total set of classified objects. For example, the root classification node 202-1 may represent medical treatments, with classification nodes 202-2, 202-3 depending from the root classification node 202-1 and representing non-surgical medical treatments and surgical medical treatments, respectively. In this case, the root classification node 202-1 may represent a parent node, while classification nodes 202-2, 202-3 may represent children nodes. Continuing with this example, the classification nodes 202-4, 202-5 depending from the non-surgical medical treatments classification node 202-2 may represent different types of non-surgical medical treatments, such as physical therapy or drug therapy, respectively. In this case the non-surgical medical treatment classification node 202-2 may represent a parent node, while classification nodes 202-4, 202-5 may represent children nodes. Consequently, while traversing the managed taxonomy 112 each classification node may have various relationships with parent nodes and children nodes. Such parent-child relationships allow the managed taxonomy system 100 to quickly traverse and find different classification nodes.

In various embodiments, the vocabulary management module 102 of the managed taxonomy system 100 may use the classification nodes 202-1 through 202-7 to classify the formal vocabulary terms 114-1-m of the managed taxonomy 112. Further, the vocabulary management module 102 may also maintain a hybrid category represented by hybrid classification node 202-8 of the managed taxonomy 112. The hybrid classification node 202-8 may be used to classify and manage an informal vocabulary term list 206 with various informal vocabulary terms 116-1-n. In one embodiment, for example, the informal vocabulary terms 116-1-n may be maintained as a flat list of keywords. A given keyword may be located by traversing the informal vocabulary terms 116-1-n in sequence until the desired informal vocabulary term 116-1-n is found.

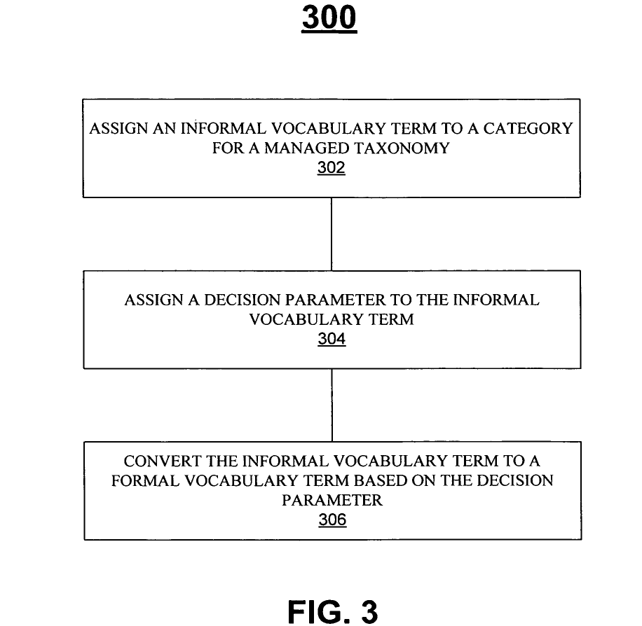

In addition to the information vocabulary terms 116-1-n, the informal vocabulary term list 206 may also maintain various decision parameters 208-1-s, where s is a positive integer, corresponding to the information vocabulary terms 116-1-n. The decision parameters 208-1-s may be used, for example, to determine whether to convert an informal vocabulary term 116-1-n to a formal vocabulary term 114-1-m. The decision parameters 208-1-s may be described in more detail below with reference to FIG. 3.

Treating ad-hoc metadata values as informal vocabulary terms 116-1-n classified using hybrid classification node 202-8 in an otherwise formally managed taxonomy allows metadata tags to be tracked, managed, related, work-flowed, mapped and secured after they have started to be used for tagging operations. The hybrid classification node 202-8 allows the managed taxonomy system 100 flexibility to add syntax, relations and context to what would otherwise be a flat list of terms. This allows ad-hoc metadata tags to evolve into the managed taxonomy 112. Further, such ad-hoc metadata tags typically have relevance, usage or weight information associated with the tags. The managed taxonomy system 100 may use such information to determine which of the many informal vocabulary terms 116-1-n should be folded into the managed taxonomy 112.

Operations for apparatus 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of apparatus 100 or alternative elements as desired for a given set of design and performance constraints.

FIG. 3 illustrates a logic flow 300. Logic flow 300 may be representative of the operations executed by one or more embodiments described herein. As shown in logic flow 300, the logic flow 300 may assign an informal vocabulary term to a category for a managed taxonomy at block 302. The logic flow 300 may assign a decision parameter to said informal vocabulary term at block 304. The logic flow 300 may convert the informal vocabulary term to a formal vocabulary term based on the decision parameter at block 306.

In one embodiment, for example, the vocabulary assignment module 104 may assign an informal vocabulary term to a category for a managed taxonomy at block 302. The vocabulary management module 104 may receive notification that a new informal vocabulary term 116-1-n has been introduced to the managed taxonomy system 100. The vocabulary assignment module 104 may store or assign the new informal vocabulary term 116-1-n to the hybrid classification node 202-8. The vocabulary manager module 102 may then initiate monitoring, analysis and conversion operations for the new informal vocabulary term 116-1-n once assigned to the hybrid classification node 202-8.

In one embodiment, for example, the vocabulary assignment module 104 may assign a decision parameter 208-1-s to the informal vocabulary term 116-1-n at block 304. The decision parameter 208-1-s may be any parameter designed to measure a characteristic or feature of an informal vocabulary term to determine whether the informal vocabulary term 116-1-n is a good candidate for conversion to a formal vocabulary term 114-1-m. In various embodiments, the decision parameter 208-1-s may comprise a usage parameter, a weighting parameter, a relationship parameter, or a relevance parameter. The number and types of decision parameters may vary according to implementation.

In one embodiment, for example, the vocabulary assignment module 104 may assign an informal vocabulary term 116-1-n a decision parameter 208-1-s comprising a usage parameter. The usage parameter may represent a number of times the informal vocabulary term 116-1-n is associated with a resource. The usage parameter may track a number of times the informal vocabulary term 116-1-n is associated with a specific resource, or any resource accessible by the managed taxonomy system 100. The former case may be particularly useful in discerning relationship patterns, while the latter case may comprise a measure of overall acceptance of the informal vocabulary term by the user population. For example, the repeated use of an informal vocabulary term 116-1-n to tag a given resource type such as a digital image may drive a taxonomist to make the informal vocabulary term 116-1-n a formal vocabulary term 114-1-m that is a default category for digital images (e.g., a copyright symbol).

In one embodiment, for example, the vocabulary assignment module 104 may assign an informal vocabulary term 116-1-n a decision parameter 208-1-s comprising a weighting parameter. The weighting parameter may represent a priority level for the informal vocabulary term 116-1-n or a resource. The weighting parameter may reflect degrees of importance or priority associated with the informal vocabulary term 116-1-n. For example, a user may designate an informal vocabulary term 116-1-n as a term for a unique or growing business trend (e.g., Web 2.0).

In one embodiment, for example, the vocabulary assignment module 104 may assign an informal vocabulary term 116-1-n a decision parameter 208-1-s comprising a relationship parameter. The relationship parameter may represent a relationship between the informal vocabulary term 116-1-n and a formal vocabulary term 114-1-m in the managed taxonomy. For example, a user population may repeatedly use an informal vocabulary term 116-1-n to tag a resource that is the same resource repeatedly tagged by a formal vocabulary term 114-1-m. This may imply some form of a relationship between the informal vocabulary term 116-1-n and the formal vocabulary term 114-1-m, such as a parent-child relationship, equality or synonym relationship, ontological relationship, user defined relationship, and so forth.

In one embodiment, for example, the vocabulary assignment module 104 may assign an informal vocabulary term 116-1-n a decision parameter 208-1-s comprising a relevance parameter. The relevance parameter may represent a level of relevance to a formal vocabulary term 116-1-n or a resource. For example, an informal vocabulary term 116-1-n such as “focal length” or “shutter speed” associated with a digital image may have a different level of relevance to a casual photographer, an amateur or hobbyist photographer, and a professional photographer. The relevance parameter may be used to track such nuances.

In one embodiment, for example, the vocabulary management module 102 may convert the informal vocabulary term 116-1-n to a formal vocabulary term 114-1-m based on the decision parameter 208-1-s at block 306. For example, the vocabulary analysis module 108 may define a threshold value for the decision parameter 208-1-s. The vocabulary analysis module 108 may compare the decision parameter 208-1-s to the defined threshold value. If the decision parameter 208-1-s exceeds the defined threshold value, the vocabulary analysis module 108 may send a signal, parameter or message to the vocabulary management module 102 indicating the informal vocabulary term 116-1-n is ready for conversion to a formal vocabulary term 114-1-m. For example, assume the decision parameter 208-1-s is a usage parameter. A threshold value of 1000 may be defined, and when an informal vocabulary term 116-1-n is used more than 1000 times for tagging or search operations, the vocabulary management module 102 may initiate further analysis operations or possibly conversion operations for the informal vocabulary term 116-1-n.

In one embodiment, for example, the vocabulary management module 102 may receive the signal from the vocabulary analysis module 108. The vocabulary management module 102 may initiate formal procedures for converting the informal vocabulary term 116-1-n to a formal vocabulary term 114-1-m. Once converted to a formal vocabulary term, the vocabulary management module 102 may insert the converted formal vocabulary term into a hierarchy of formal vocabulary terms for the managed taxonomy. Furthermore, the vocabulary management module 102 may begin defining various rights, attributes, syntax rules, equality relationships, ontological relationships, context parameters, and so forth, as with any formal vocabulary term 114-1-m within the managed taxonomy 112.

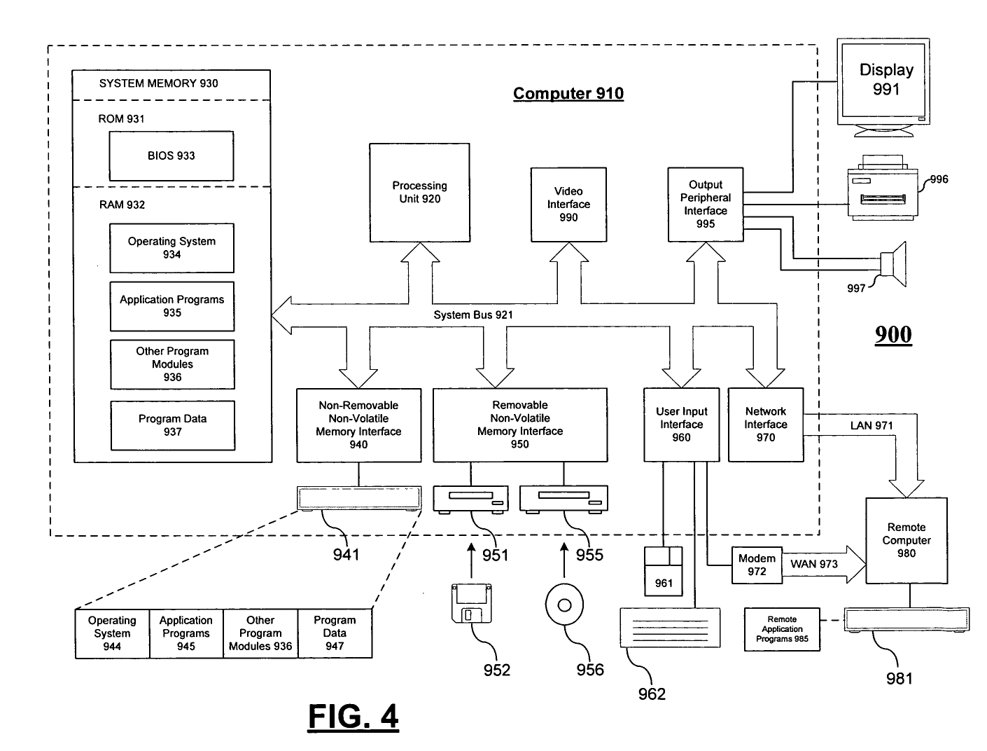

FIG. 4 illustrates a block diagram of a computing system architecture 900 suitable for implementing various embodiments, including the managed taxonomy system 100. It may be appreciated that the computing system architecture 900 is only one example of a suitable computing environment and is not intended to suggest any limitation as to the scope of use or functionality of the embodiments. Neither should the computing system architecture 900 be interpreted as having any dependency or requirement relating to any one or combination of components illustrated in the exemplary computing system architecture 900.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 4, the computing system architecture 900 includes a general purpose computing device such as a computer 910. The computer 910 may include various components typically found in a computer or processing system. Some illustrative components of computer 910 may include, but are not limited to, a processing unit 920 and a memory unit 930.

In one embodiment, for example, the computer 910 may include one or more processing units 920. A processing unit 920 may comprise any hardware element or software element arranged to process information or data. Some examples of the processing unit 920 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 920 may be implemented as a general purpose processor. Alternatively, the processing unit 920 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 910 may include one or more memory units 930 coupled to the processing unit 920. A memory unit 930 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 910. The embodiments are not limited in this context.

In one embodiment, for example, the computer 910 may include a system bus 921 that couples various system components including the memory unit 930 to the processing unit 920. A system bus 921 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 910 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 900. Examples of computer readable media for computing system architecture 900 may include, but are not limited to, volatile and/or nonvolatile memory such as ROM 931 and RAM 932. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 930 includes computer storage media in the form of volatile and/or nonvolatile memory such as ROM 931 and RAM 932. A basic input/output system 933 (BIOS), containing the basic routines that help to transfer information between elements within computer 910, such as during start-up, is typically stored in ROM 931. RAM 932 typically contains data and/or program modules that are immediately accessible to and/or presently being operated on by processing unit 920. By way of example, and not limitation, FIG. 4 illustrates operating system 934, application programs 935, other program modules 936, and program data 937.

The computer 910 may also include other removable/non-removable, volatile/nonvolatile computer storage media. By way of example only, FIG. 4 illustrates a hard disk drive 940 that reads from or writes to non-removable, nonvolatile magnetic media, a magnetic disk drive 951 that reads from or writes to a removable, nonvolatile magnetic disk 952, and an optical disk drive 955 that reads from or writes to a removable, nonvolatile optical disk 956 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 941 is typically connected to the system bus 921 through a non-removable memory interface such as interface 940, and magnetic disk drive 951 and optical disk drive 955 are typically connected to the system bus 921 by a removable memory interface, such as interface 950.

The drives and their associated computer storage media discussed above and illustrated in FIG. 4, provide storage of computer readable instructions, data structures, program modules and other data for the computer 910. In FIG. 4, for example, hard disk drive 941 is illustrated as storing operating system 944, application programs 945, other program modules 946, and program data 947. Note that these components can either be the same as or different from operating system 934, application programs 935, other program modules 936, and program data 937. Operating system 944, application programs 945, other program modules 946, and program data 947 are given different numbers here to illustrate that, at a minimum, they are different copies. A user may enter commands and information into the computer 910 through input devices such as a keyboard 962 and pointing device 961, commonly referred to as a mouse, trackball or touch pad. Other input devices (not shown) may include a microphone, joystick, game pad, satellite dish, scanner, or the like. These and other input devices are often connected to the processing unit 920 through a user input interface 960 that is coupled to the system bus, but may be connected by other interface and bus structures, such as a parallel port, game port or a universal serial bus (USB). A monitor 991 or other type of display device is also connected to the system bus 921 via an interface, such as a video interface 990. In addition to the monitor 991, computers may also include other peripheral output devices such as speakers 997 and printer 996, which may be connected through an output peripheral interface 990.

The computer 910 may operate in a networked environment using logical connections to one or more remote computers, such as a remote computer 980. The remote computer 980 may be a personal computer (PC), a server, a router, a network PC, a peer device or other common network node, and typically includes many or all of the elements described above relative to the computer 910, although only a memory storage device 981 has been illustrated in FIG. 4 for clarity. The logical connections depicted in FIG. 4 include a local area network (LAN) 971 and a wide area network (WAN) 973, but may also include other networks. Such networking environments are commonplace in offices, enterprise-wide computer networks, intranets and the Internet.

When used in a LAN networking environment, the computer 910 is connected to the LAN 971 through a network interface or adapter 970. When used in a WAN networking environment, the computer 910 typically includes a modem 972 or other technique suitable for establishing communications over the WAN 973, such as the Internet. The modem 972, which may be internal or external, may be connected to the system bus 921 via the user input interface 960, or other appropriate mechanism. In a networked environment, program modules depicted relative to the computer 910, or portions thereof, may be stored in the remote memory storage device. By way of example, and not limitation, FIG. 4 illustrates remote application programs 985 as residing on memory device 981. It will be appreciated that the network connections shown are exemplary and other techniques for establishing a communications link between the computers may be used. Further, the network connections may be implemented as wired or wireless connections. In the latter case, the computing system architecture 900 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the managed taxonomy system 100 and/or computing system architecture 900 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously provided for the memory unit 130. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
assigning an informal vocabulary term to a category for a managed taxonomy;
assigning a decision parameter to said informal vocabulary term; and
converting said informal vocabulary term to a formal vocabulary term based on said decision parameter.

2. The method of claim 1, said decision parameter comprising a usage parameter, a weighting parameter, a relationship parameter, or a relevance parameter.

3. The method of claim 1, comprising assigning said informal vocabulary term a decision parameter comprising a usage parameter to represent a number of times said informal vocabulary term is associated with a resource.

4. The method of claim 1, comprising assigning said informal vocabulary term a decision parameter comprising a weighting parameter to represent a priority level for said informal vocabulary term or a resource.

5. The method of claim 1, comprising assigning said informal vocabulary term a decision parameter comprising a relationship parameter to represent a relationship between said informal vocabulary term and a formal vocabulary term in said managed taxonomy.

6. The method of claim 1, comprising assigning said informal vocabulary term a decision parameter comprising a relevance parameter to represent a level of relevance to a formal vocabulary term or a resource.

7. The method of claim 1, comprising converting said informal vocabulary term to a formal vocabulary term if said decision parameter exceeds a defined threshold value.

8. The method of claim 1, comprising inserting said converted formal vocabulary term into a hierarchy of formal vocabulary terms for said managed taxonomy.

9. An article comprising a storage medium containing instructions that if executed enable a system to:
assign an informal vocabulary term to a category for a managed taxonomy;
assign a decision parameter to said informal vocabulary term;
monitor said assigned decision parameter; and
convert said informal vocabulary term to a formal vocabulary term based on said decision parameter.

10. The article of claim 9, further comprising instructions that if executed enable the system to assign said informal vocabulary term a decision parameter comprising a usage parameter to represent a number of times said informal vocabulary term is associated with a resource.

11. The article of claim 9, further comprising instructions that if executed enable the system to assign said informal vocabulary term a decision parameter comprising a weighting parameter to represent a priority level for said informal vocabulary term or a resource.

12. The article of claim 9, further comprising instructions that if executed enable the system to assign said informal vocabulary term a decision parameter comprising a relationship parameter to represent a relationship between said informal vocabulary term and a formal vocabulary term in said managed taxonomy.

13. The article of claim 9, further comprising instructions that if executed enable the system to assign said informal vocabulary term a decision parameter comprising a relevance parameter to represent a level of relevance to a formal vocabulary term or a resource.

14. The article of claim 9, further comprising instructions that if executed enable the system to convert said informal vocabulary term to a formal vocabulary term if said decision parameter exceeds a defined threshold value.

15. The article of claim 9, further comprising instructions that if executed enable the system to insert said converted formal vocabulary term into a hierarchy of formal vocabulary terms for said managed taxonomy.

16. An apparatus comprising a managed taxonomy system having a vocabulary management module to manage a taxonomy of formal vocabulary terms organized in a hierarchical structure, said taxonomy having a category for informal vocabulary terms stored as a list of keywords.

17. The apparatus of claim 16, comprising a vocabulary assignment module to assign a decision parameter to an informal vocabulary term.

18. The apparatus of claim 16, comprising a vocabulary association module to associate an informal vocabulary term with a resource.

19. The apparatus of claim 16, comprising a vocabulary analysis module to analyze a decision parameter for an informal vocabulary term, and convert said informal vocabulary term to a formal vocabulary term based on said decision parameter.

20. The apparatus of claim 16, comprising a vocabulary analysis module to convert an informal vocabulary term to a formal vocabulary term based on usage of said informal vocabulary term.
